(19) United States
(12) Patent Application Publication
(10) Pub. No.: US 2014/0022183 A1
(43) Pub. Date: Jan. 23, 2014

(54) SENDING AND RECEIVING INFORMATION

(71) Applicants: Ramy S. Ayoub, Arlington Heights, IL (US); Joseph F. Wodka, Hoffman Estates, IL (US)

(72) Inventors: Ramy S. Ayoub, Arlington Heights, IL (US); Joseph F. Wodka, Hoffman Estates, IL (US)

(73) Assignee: GENERAL INSTRUMENT CORPORATION, Horsham, PA (US)

(21) Appl. No.: 13/552,673

(22) Filed: Jul. 19, 2012

(51) Int. Cl. G06F 3/041

(52) U.S. Cl. 345/173

(57) ABSTRACT

Disclosed are methods and apparatus for sending information from a first computer to a second computer. The first computer may comprise a gesture module, a device-detection module, and a transmission module. The method may comprise receiving, by the gesture module, an input. The input may specify the information that is to be sent and a direction relative to the first computer. The input may have been generated by a user of the first computer performing a gesture. Using the specified direction, the device-detection module may then identify the second computer. The second computer may be located relative to the first computer substantially in the specified direction. The specified information may then be sent, by the transmission module, to the second computer.

### FIELD OF THE INVENTION

The present invention is related generally to sending and receiving information among computers.

### BACKGROUND OF THE INVENTION

Many conventional computers, in particular portable computers, e.g., smartphones, tablet computers, etc., comprise touch-sensitive systems, e.g., touch-screen displays and touch-sensitive bezels.

Use of these computers often includes sending information (e.g., multimedia content) between two or more different devices.

There tends to be a need for easy and intuitive ways of sending information among two or more different computers that comprise touch-sensitive systems.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) of a first computer;

FIG. 2 is a process flow chart showing certain steps of an embodiment of a process of sending and receiving information;

FIG. 3 is a schematic illustration (not to scale) of an example scenario in which the method of FIG. 2 may be implemented;

FIG. 4 is a schematic illustration (not to scale) showing an icon being selected by a first user;

FIG. 5 is a schematic illustration (not to scale) showing part of a gesture performed by the first user to send information;

FIG. 6 is a schematic illustration (not to scale) showing another part of a gesture performed by the first user to send information;

FIG. 7 is a schematic illustration (not to scale) of multiple devices in a send and receive ecosystem.

FIG. 8 is a schematic illustration (not to scale) showing part of a gesture performed by a second user to receive information; and

FIG. 9 is a schematic illustration (not to scale) showing another part of a gesture performed by the second user to receive information.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Embodiments of the invention provide methods and apparatus for sharing information (e.g., multimedia content) among devices that may comprise touch-screen displays and touch-sensitive bezels. The sending and receiving of information from a first computer to a second computer may comprise performing (by a user of the first computer) a directional gesture, i.e., a gesture that specifies a direction. This direction may be used to identify the second computer.

Apparatus for implementing any of the below described arrangements, and for performing any of the below described method steps, may be provided by configuring or adapting any suitable apparatus, for example one or more computers or other processing apparatus or processors, or providing additional modules. The apparatus may comprise a computer, a network of computers, or one or more processors for implementing instructions and using data, including instructions and data in the form of a computer program or plurality of computer programs stored in or on a machine-readable storage medium such as computer memory, a computer disk, ROM, PROM, etc., or any combination of these or other storage media.

It should be noted that certain of the process steps depicted in the below described process flowcharts may be omitted or such process steps may be performed in an order differing from that presented below and shown in those process flowcharts. Furthermore, although all the process steps have, for convenience and ease of understanding, been depicted as discrete temporally-sequential steps, nevertheless some of the process steps may in fact be performed simultaneously or at least overlapping to some extent temporally.

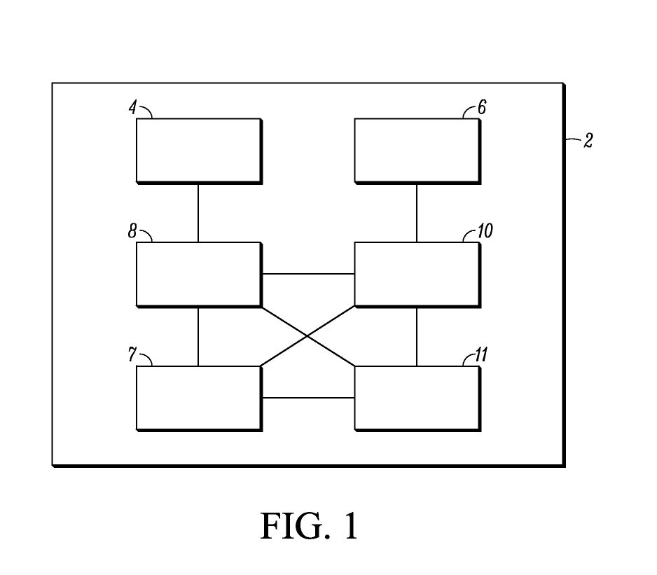

Referring now to the Figures, FIG. 1 is a schematic illustration (not to scale) showing an example of a first computer 2. The first computer 2 may be any appropriate type of computer and may be configured in any appropriate way. For example, the first computer 2 may be a desktop personal computer, a laptop computer, a tablet computer, a mobile station, an entertainment appliance, a set-top box communicatively coupled to a television, a wireless phone, a smartphone, a netbook, a game console, etc.

The first computer 2 comprises a bezel 4, a display 6, a transceiver 7, a bezel-gesture module 8, a display-gesture module 10, and a device-detection module 11.

The bezel 4 forms part of the housing of the first computer 2. The bezel 4 comprises a frame structure that may be adjacent to (e.g., at least partly surrounding) the display 6.

The display 6 may be a touch-screen display. Some or all of the display 6 may extend underneath the bezel 4 to some extent. Also, some or all of the display 6 may not extend underneath bezel 4, and instead at least a portion of the display 6 may lie flush with the bezel 4.

The transceiver 7 is a conventional transceiver that may transmit information from the first computer 2 for use by an entity remote from the first computer 2 and may receive information from an entity that is remote from the first computer 2. The transceiver may be connected to the gesture modules 8, 10 and to the device-detection module 11.

The gesture modules 8, 10 may each comprise one or more processors. The functionality of the bezel-gesture module 8 and of the display-gesture module 10 may be to recognize bezel gestures and display gestures (e.g., gestures made by a user of the first computer 2) respectively. Further functionality of the gesture modules 8, 10 may be to cause operations that correspond to the gestures to be performed.

The bezel-gesture module 8 is configured to recognize a touch input to the bezel 4. Such a touch input may, for example, be made by a user of the first computer 2 touching the bezel 4 (or a portion of the first computer 2 proximate to the bezel 4) with his finger (i.e., one of his digits). Such, a touch input may, for example, initiate or end a gesture. Any suitable technology may be utilized to sense such a touch input.

The display-gesture module 10 is configured to recognize a touch input to the display 6. Such a touch input may, for example, be made by a user of the first computer 2 touching the display 6 (or a portion of the first computer 2 proximate to the display) with his finger. Such, a touch input may, for example, initiate or end a gesture. Any suitable technology may be utilized to sense such a touch input.

The gesture modules 8, 10 may be connected together such that information may be sent between the modules 8, 10. This is such that gestures that involve touch inputs to both the bezel 4 and to the display 6 may be processed. The gesture modules 8, 10 may be implemented using any suitable type of hardware, software, firmware, or combination thereof. In other embodiments, the functionality provided by the gesture modules 8, 10 may be provided by a single module. The gesture modules 8, 10 may be configured such that they can detect a change from a touch input to the bezel 4 and a touch input to the display 6, and vice versa.

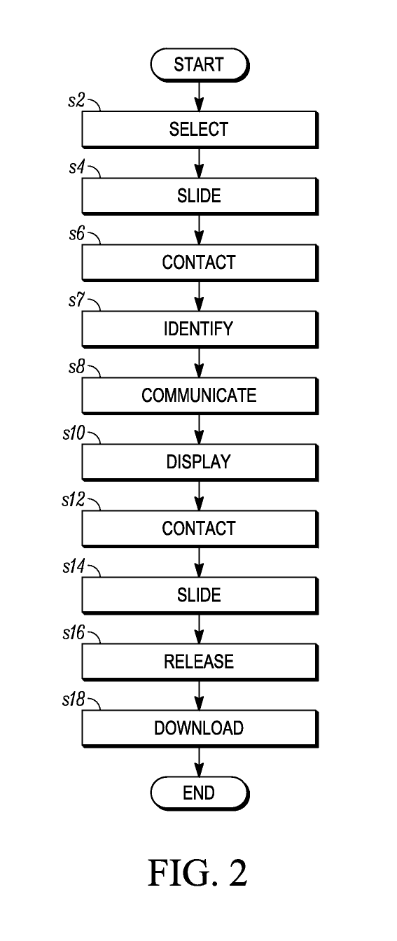

The device-detection module 11 may be configured to detect or identify other systems or apparatus (e.g., other computers) that may in the vicinity of the first computer 2. The functionality of the device-detection module 11 is described in more detail below with reference to FIG. 2. The device-detection module 11 may be implemented using any suitable type of hardware, software, firmware, or combination thereof. Any suitable technology may be utilized by the detection module 11 to detect or identify other systems or apparatus (e.g., other computers) that may in the vicinity of the first computer 2. For example, the device-detection module 11 may comprise one or more radiated communication systems (e.g., Bluetooth™, WiFi, Near field communication) which may enable that device to discern the position of another device relative to that of the first computer 2 (e.g., a Bluetooth™ communication link between the device-detection module 11 of the first computer 2 and another device may enable the device-detection module 11 to discern a direction, relative to the first computer 2, in which that other device is located). Also for example, the device-detection module 11 may comprise a global positioning system (GPS) or make use of GPS data to discern the position of another device relative to that of the first computer 2 (e.g., the device-detection module 11 may acquire GPS locations for itself and for the other device, and also an orientation for the first computer 2, and use these to determine a direction, relative to the first computer 2, in which that other device is located). Also, the device-detection module 11 may comprise a system for determining the orientation of the first computer 2. The determination of the orientation of the first computer 2 may be used, by the device-detection module 11, to determine a direction, relative to the first computer 2, in which another device is located. In some embodiments, the device-detection module 11 may comprise a plurality of antennas located at different positions in or on the first computer 2. These antennas may receive a signal from another device that is remote from the first computer 2. The signal strengths measured by the plurality of antenna may then enable the direction, relative to the first computer 2, in which the other device is located to be determined.

FIG. 2 is a process flow chart showing certain steps of an embodiment of a process by which information may be sent from the first computer 2 to a second computer and received at that second computer.

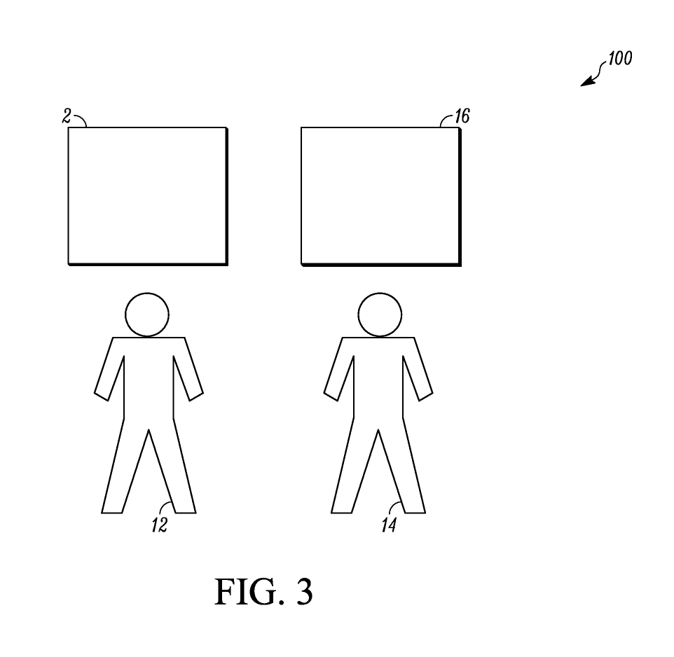

FIG. 3 is a schematic illustration (not to scale) of an example scenario 100 in which the method of FIG. 2 may be implemented. In this scenario 100, a first user 12 operates the first computer 2 and a second user 14 operates the second computer 16. The second computer 16 may be the same type of device as the first computer 2 (i.e., the second computer may comprise the same type of modules as those shown in FIG. 1). In other scenarios, the second computer 16 is a type of computer different from the first computer 2.

The information being sent from the first computer 2 to the second computer 16 may be any type of digital information (e.g., a computer file, a computer program, a web-link, etc).

At step s2 of FIG. 2, using the first computer 2, the first user 12 selects the information he wishes to send. This may be done in any appropriate way. For example, the first user 12 may select an icon corresponding to the information he wishes to send, e.g., by touching, on the display 6, that icon with his finger (or a stylus). Contact of the finger with the display 6 may be detected by the display-gesture module 10. In other embodiments, the information to be sent may be selected in a different way.

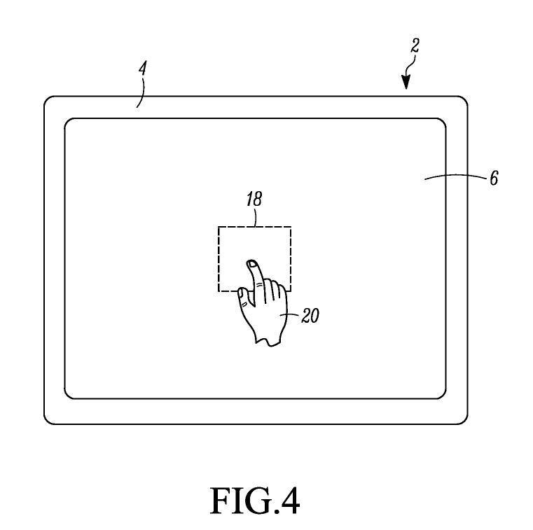

FIG. 4 is a schematic illustration (not to scale) showing an icon 18 (corresponding to the information to be sent) being selected by the first user 12 by the first user 12 touching that icon 18 on the display 6 with his finger 20.

At step s4, the first user 12 may slide his finger 20 across the display 6 towards an edge of the display 6, i.e., towards the bezel 4. Movement of the first user's finger 20 across the display 6 may be detected by the display-gesture module 10. The display-gesture module 10 may then recognize or identify this movement as indicating a “drag” operation. The position of the icon 18 on the display 6 may be changed so that the icon 18 is positioned at the point on the display 6 that is being touched by the first user's finger 20.

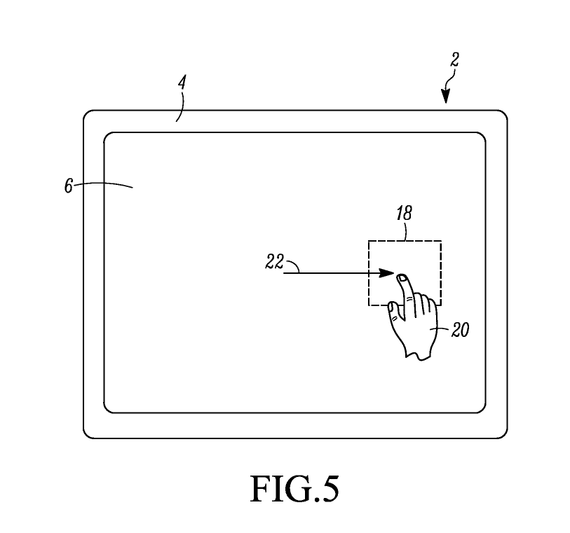

FIG. 5 is a schematic illustration (not to scale) showing the first user 12 sliding his finger 20 across the display 6 towards the bezel 4. The movement of the first user's finger 20 across the display 6 is indicated in FIG. 5 by a solid arrow and the reference numeral 22.

At step s6, the first user 12 continues to slide his finger 20 across the display 6 until his finger 20 contacts the bezel 4. Contact of the first user's finger 20 with the bezel 4 may be detected by the bezel-gesture module 8.

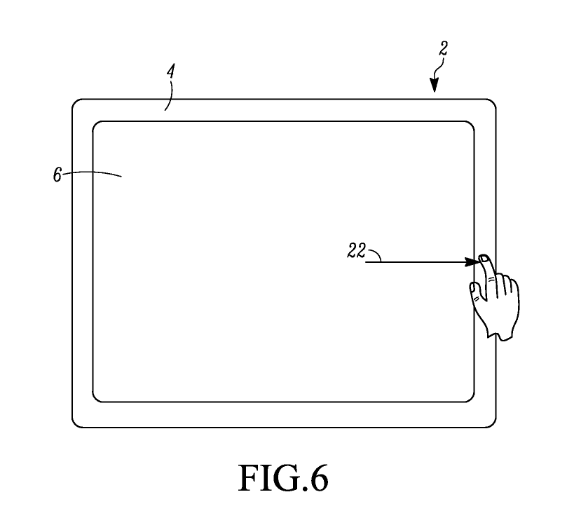

FIG. 6 is a schematic illustration (not to scale) showing a position of the first user's finger 20 after it has been slid across the display and moved into contact with the bezel 4.

The bezel-gesture module 8 and the display-gesture module 10 may recognize or identify the gesture performed during steps s2 through s6 as corresponding to a “select and send” operation, i.e., an operation by which information to be sent may be selected and sent from the first computer 2. In other embodiments the “select and send operation” may additionally comprise the first user 12 moving his finger 20 so it no longer touches the first computer 2 (e.g., by sliding his finger 20 off the edge of the bezel 4). In other words, the gesture performed by the first user 12 using his finger 20 and comprising swiping and dragging the icon or content across the display 6, then simultaneously touching the display 6 and the bezel 4, and then continuing this motion across the bezel 4 alone, may represent or indicate the first user's intention to copy or move content to another computer.

At step s7, the direction in which the first user 12 moves his finger 20 across the display 6 and bezel 4 (i.e., the direction of the “user swipe”) may be used to select a device to which the selected information is to be sent. In this embodiment, the first user 12 may swipe in the direction of the second computer 16 thereby, in effect, selecting that second device 16 as a desired recipient for the information. (Note that different detection technologies allow different levels of precision when detecting the direction of the second computer 16 relative to the first computer 2. Human imprecision also limits the exactness that can be expected. With these considerations in mind, a second computer 16 may be “substantially” in the required direction even with an error of up to 45 degrees in any direction.)

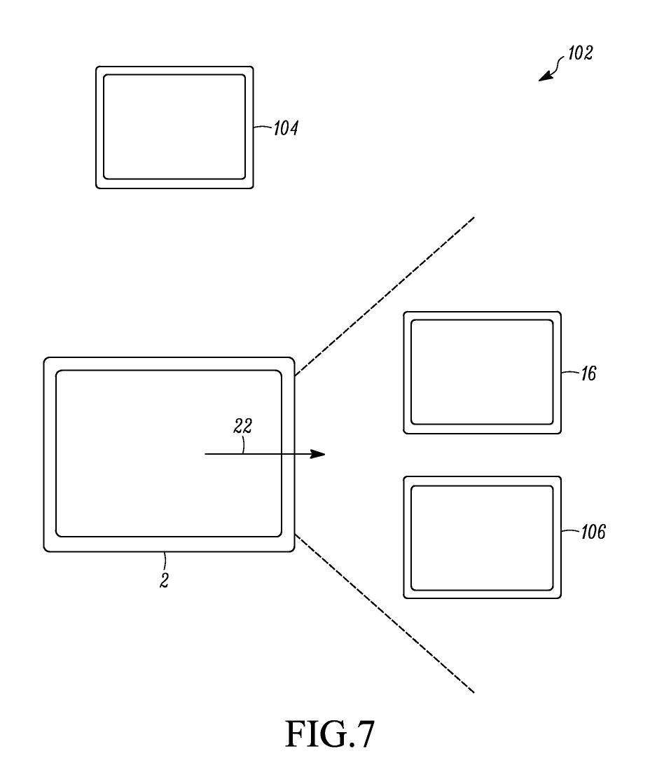

For example, FIG. 7 is a schematic illustration (not to scale) of a further scenario 102 in which there are multiple potential receivers (i.e., multiple further computers) for the information being sent from the first computer 2.

In this further scenario 102, the second computer 16 is located to the right of the first computer 2. Also, there are two further computers, namely a third computer 104 and a fourth computer 106. The third computer 104 is located in front of the first computer 2. The fourth computer 106 is located to the right of the first computer 2 (i.e., in the same direction as the second computer 16). The third and fourth computers 104, 106 may be the same type of computers as the first and second computers 2, 16.

Each of the computers 2, 16, 104, 106 may comprise device-detection modules (such as the device-detection module 11 described above with reference to FIG. 1) which allows the computer to discern the relative positions of the other devices (that are in the proximity of that computer). For example, in the further scenario 102, the device-detection module 11 of the first computer 2 may discern the locations of the second computer 16, the third computer 104, and the fourth computer 106 relative to the first computer 2. Thus, when the first user 12 swipes his finger 20 across the display 6 and bezel 4 in the direction of the arrow 22 shown in FIG. 7 (i.e., to the right of the first computer 2), the device-detection module 11 of the first computer 2 may determine that the selected content is to be sent to either the second computer 16 or the fourth computer 106 (i.e., not to the third computer 104). The device-detection module 11 of the first computer 2 may then decide which particular computer (i.e., either the second computer 16 or the fourth computer 106) to send the information to based on any appropriate criteria. For example, the first computer 2 may attempt to send the information to each device (that is located to the right of the first computer 2) that belongs to a contact of the first user 12 (a list of which may be stored in the first computer 2). Alternatively, the first computer 2 may attempt to send the information to each device (that is located to the right of the first computer 2) that belongs to a member of a social network of the first user 12 (a list of whom may be accessible by the first computer 2). Alternatively, the first user 12 may be given an opportunity to select which devices the content is to be sent to (e.g., a list of potential receivers may be displayed to the first user 12, and the first user 12 may select a target for the content from this list).

In this scenario, the second computer 16 is identified as the target for the content by the first computer 2 or the first user 12.

Returning to FIG. 2, at step s8, the first computer 2 may communicate with the device selected at step s7, i.e., the device selected as the device to which the selected content is to be sent, i.e., the second computer 16. This may be performed in any appropriate way, e.g., via the transceiver 7. This may be performed to inform the second computer 16 that information is to be sent from the first computer 2 to the second computer 16.

At step s10, the second computer 16 informs its second user 14 that information is to be sent to the second computer 16. This may, for example, be performed by displaying, to the second user 14, an indication or notification, e.g., on a display of the second user device 16 (hereinafter referred to as “the further display”). This displayed indication may, for example, give the second user 14 an option to “accept” the information (i.e., allow information sent from the first computer 2 to be received by the second computer 16) or “decline” the information (i.e., not allow information sent from the first computer 2 to be received by the second computer 16) from the first computer 2.

Next described with reference to steps s12 through s16 is an example method that may be performed by the second user 14 to accept the information from the first computer 2.

At step s12, the second user 12 may touch, e.g., with his finger or a stylus, a bezel of the second computer 16 (hereinafter referred to as “the further bezel”). Contact of the second user's finger with the further bezel may be detected by a bezel-gesture module of the second computer (hereinafter referred to as “the further bezel-gesture module”).

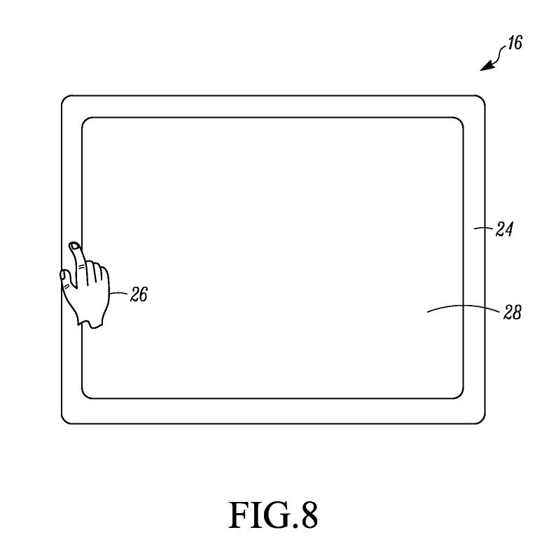

FIG. 8 is a schematic illustration (not to scale) showing the second user 14 touching the further bezel 24 (i.e., the bezel of the second computer 16) with his finger 26. The further display (i.e., the display of the second computer 16) is indicated in FIG. 8 by the reference numeral 28.

At step s14, the second user 14 may slide his finger 26 from the further bezel 24 onto the further display 28 and across the further display 28 to some point on the further display 28.

Movement of the second user's finger 26 from the further bezel 24 and onto and across the further display 28 may be detected by the further bezel-gesture module and a display-gesture module of the second computer 16 (hereinafter referred to as “the further display-gesture module”).

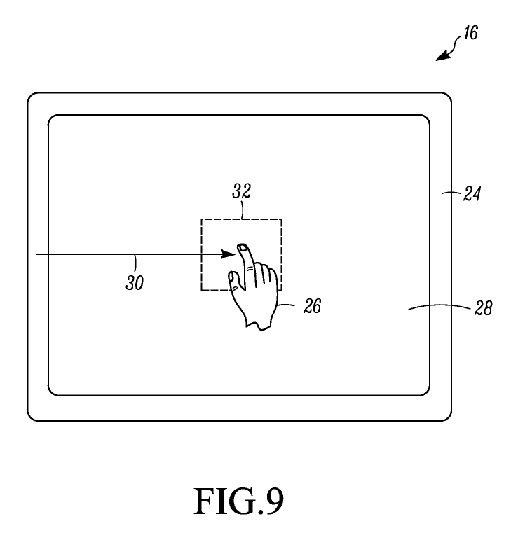

FIG. 9 is a schematic illustration (not to scale) showing the second user 14 sliding his finger 26 from the further bezel 24 and onto and across the further display 28. The movement of the second user's finger 26 is indicated in FIG. 9 by a solid arrow and the reference numeral 30.

At step s16, the second user 14 may move his finger 26 so that it no longer touches the second computer 16 (e.g., by moving his finger 26 away from the further display 28). The further bezel-gesture module and the further display gesture model of the second computer 16 may recognize or identify this “drag and drop” type gesture (i.e., the gesture performed by the second user 14 during steps s12 through s16) as corresponding to a “receive information” operation, i.e., an operation that initiates the receiving (e.g., the downloading) of the information sent by the first computer 2 onto the second computer 16.

In a similar way to how the direction was indicated by the first user's gesture (performed at steps s2 to s6), a direction indicated by the second user's gesture (performed at steps s12 to s16), i.e., the direction that the second user 14 swipes his finger 26 across the further bezel 24 and further display 28 may select a device from which the content is to be received. For example, in the further scenario 102 of FIG. 7, the first computer 2 is located to the left of the second computer 16. Also, the fourth computer 106 is located below the second computer 16. If both the first computer 2 and the fourth computer 106 were to attempt to send information to the second computer 16, then the second user 14 may select which of those devices 2, 106 to receive information from using the gesture of steps s12 to s16. For example, if the second user 14 wishes to receive content from the first computer 2, then the second user 14 may swipe his finger 26 across the further bezel 24 and onto the further display 28 from the direction in which the first computer 2 is located relative to the second computer 16 (i.e., from the left hand edge of the further bezel 24 and onto the further display 28 from its left hand side). Likewise, if the second user 14 wishes to receive content from the fourth computer 106, the second user 14 may swipe his finger 26 across the further bezel 24 and onto the further display 28 from the direction in which the fourth computer 106 is located relative to the second computer 16 (i.e., from the bottom edge of the further bezel 24 and onto the further display 28 from its bottom-most side).

At step s18, the information sent by the first computer 2 is received (e.g., downloaded) by the second computer 16 (e.g., by a transceiver of the second computer 16).

Thus, a process by which information may be sent from the first computer 2 to the second computer 16, and received at that second computer 16, is provided.

The above described method and apparatus utilize a “swipe,” “flick,” or “fling” type gesture that incorporates both a touch-screen display and a touch-sensitive bezel to share content between users. The gesture used by a user is advantageously intuitive and allows the first user to “push” content from his computer (the first computer) to the second user's computer (the second computer) by touching the content and dragging it across the screen and bezel of the first computer in the direction of the second computer. The utilization of both the touch-screen display and touch-sensitive bezel advantageously facilitate in the differentiation (e.g., by the gesture modules) between “select and share” operations and conventional “drag and drop” operations.

Furthermore, the “fling” type gesture advantageously tends to provide that only devices that are in the direction that is indicated by the gesture are identified as targets to send content to. Thus, not to all devices in the vicinity of the sending device are targeted or communicated with during the transmission process. This advantageously tends to allow a user to easily (and using an intuitive gesture) select content for transmission and specify a target device to which to send that content.

A computer that is to receive content may advantageously display an indicator to the user of that device. This indicator may be any appropriate type of indicator. The indicator may be a message or dialog box displayed to the user. It may also be a symbolic icon, representing the action to the user. The indicator may indicate, to the user of the receiving device, that content is being transferred (or is to be transferred, etc.) to the receiving device. The indicator may be any appropriate type of indicator and may provide further information to the user of the receiving device. For example, the indicator may give an indication of the direction of the sending device relative to the receiving device (i.e., an indication of the direction from which the content is being transferred). Also, the indication may indicate the type of content or provide a representation of the specific content itself. Also, the indication may indicate a time limit to the user by which the user must accept (or decline) the content. If the user does not explicitly permit the content to be received or downloaded by the receiving computer within that time limit (e.g., by performing the gesture described above with reference to steps s12 through s16 of FIG. 2), then the content may not be received or downloaded by the receiving computer. This time limit may be communicated to the user, e.g., by a countdown timer displayed on the display of the receiving device, the indicator fading out (and eventually disappearing) over the time limit, the indicator moving across the display of the receiving device (and eventually off the display) over the time limit, or in any other appropriate way.

The performance, by the second user, of an action (e.g., the gesture performed by the second user and described above with reference to steps s12 through s16 of FIG. 2) that, in effect, gives that the second user's permission for content sent from the first computer to be received by the second computer advantageously tends to provide a level of security for the second user and the second user device. This may be provided by giving the second user the option to decline content (i.e., oppose it being received or downloaded by the second computer) that he may suspect as harmful. Additionally, the indicator that may be displayed to the second user may indicate the identity of the first user or the first computer (i.e., the identity of the party sending the content). The second user may use this information when deciding whether or not to accept it. Additionally, passcodes may be used to encrypt information before it is sent, thereby providing an additional level of security. Additionally, any Digital Rights Management protecting the content or information to be transferred or shared may be enforced. For example, if the information to be transferred is copy protected, then its transmission to another device may be opposed.

Advantageously, the content that is sent from the first computer to the second computer may be any appropriate type of content. For example, the content to be sent may be content that is stored on the first computer (e.g., pictures, video, documents, etc.). Also for example, the content to be sent may be “referenced content,” e.g., a uniform resource locator (URL) for an Internet resource. For example, the first user may be watching an online video (e.g., a YouTube™ video). The first user may send this video to the second user, e.g., by touching the video being played and dragging it across the display of the first computer to the bezel of the first computer in the direction of the second user (i.e., the first user may perform the above described steps s2 through s6 of FIG. 2). The second user may then drag his finger across the bezel of the second computer, from the direction of the first user, to a location on the display of the second computer where he would like the video to be displayed. The second computer may then, using the received URL, display the video to the second user.

Advantageously, an intuitive and secure method for sending and receiving content between devices is provided. The disclosed method and apparatus is particularly useful for sending and receiving content between devices that are in relatively close proximity.

In the above embodiments, the gestures performed to send and receive information comprise touching (e.g., with a finger or a stylus) a touch-sensitive bezel. However, in other embodiments, one or both of these gestures may not include use of a touch-sensitive bezel. Instead, for example, the functionality provided by the bezel may be provided by a different system, apparatus, or module. For example, a portion of the display (e.g., a region of the display around the edge of the display) may replace the bezel in the above described embodiments. A user's directional gesture may, for example, comprise the user sliding his finger across the display and into contact with an edge region of the display. The user may continue to slide his finger off the display completely.

In above embodiments, the apparatus (i.e., the computer) that detects the user's gesture (i.e., the directional gesture that the user uses to send or receive information) may comprise a touch-screen display and a touch-sensitive bezel. However, in other embodiments, a directional gesture of the user may be detected in a different way by one or more different modules. For example, in other embodiments the user may perform a gesture without touching a device at all. For example, whilst the user performs a directional gesture, the user's movements may be measured or detected (e.g., using one or more cameras or imaging systems). These measurements may then be used to determine a direction being specified by the user. Such systems and apparatus tend to be particularly useful in devices which do not comprise touch-screen displays, e.g., a set-top box operatively coupled to a television. In other embodiments, a set-top box and television (TV) may be operatively coupled to a camera system (or other gesture-recognition system). The TV may display, e.g., an icon. The user may point (e.g., with his finger) to that and move his hand in a dragging or sweeping gesture across the screen and then off the screen in the direction of the device that is to receive data associated with the icon. The camera system coupled to the set-top box and TV (or other gesture-recognition system) may detect the gesture.

In the above embodiments, the gesture described above with reference to FIGS. 8 and 9 is performed on a device to indicate that information that has been sent to that device (or information for which an attempt has been made to send that information to that device) should be received by that device. However, in other embodiments, the gesture described above with reference to FIGS. 8 and 9 may be performed on a device to retrieve information from a different device. In other words, the gesture may be used on a receiving device to “pull” information onto that receiving device from a separate sending device. This may include, for example, situations where the decision as to the choice of which content, e.g., which document, file, multimedia content, etc., is to be sent is performed entirely by or using the receiving device.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of sending information from a first computer to a second computer, the first computer comprising a gesture module, a device-detection module, and a transmission module, the method comprising:
receiving, by the gesture module, an input, the input specifying or identifying information that is to be sent from the first computer to the second computer, the input specifying a direction relative to the first computer, the input being generated by a user of the first computer performing a gesture;
identifying, using the direction specified by the input, by the device-detection module, the second computer, the second computer being located relative to the first computer substantially in the direction specified by the input; and
sending, by the transmission module, to the second computer, the information specified or identified by the input.

2. A method according to claim 1:
wherein the first computer further comprises a touch-sensitive display;
wherein the input is received by the gesture module from the display; and
wherein the gesture comprises the user contacting, with an entity, the display.

3. A method according to claim 2 wherein the gesture that generates the input comprises:
contacting, by the user, a point on the display with the entity; and
sliding, by the user, the entity across at least a portion of the display.

4. A method according to claim 3:
wherein contacting, by the user, a point on the display with the entity specifies or identifies the information that is to be sent from the first computer to the second computer; and
wherein sliding the entity, by the user, across at least a portion of the display specifies the direction relative to the first computer, the specified direction being the direction in which the entity is slid by the user.

5. A method according to claim 2:
wherein the first computer further comprises a bezel;
wherein the bezel is a touch-sensitive bezel;
wherein the input is received by the gesture module from the display and from the bezel; and
wherein the gesture comprises the user contacting, with an entity, the display and the bezel.

6. A method according to claim 5 wherein the gesture that generates the input comprises:
contacting, by the user, a point on the display with the entity; and
sliding, by the user, the entity across at least a portion of the display and into contact with the bezel.

7. A method according to claim 6:
wherein contacting, by the user, a point on the display with the entity specifies or identifies the information that is to be sent from the first computer to the second computer; and
wherein sliding the entity, by the user, across the display and into contact with the bezel specifies the direction relative to the first computer, the specified direction being the direction in which the entity is slid by the user.

8. A method according to claim 1 wherein identifying the second computer comprises:
identifying, by the device-detection module, a plurality of computers, the second computer being one of the plurality of computers, each of the plurality of computers being located relative to the first computer substantially in the direction specified by the input; and
selecting, from the plurality of computers, the second computer;
wherein selecting the second computer comprises a step from the group consisting of:
selecting as the second computer a computer corresponding to a contact of the user of the first computer and
selecting as the second computer a computer corresponding to a member of a social network of the user of the first computer.

9. A method according to claim 1 wherein the device-detection module is selected from the group consisting of: a radiated communication system, a global positioning system, a system configured to determine an orientation of the first computer, and a plurality of antennas located at different positions and configured to receive a signal from the second computer and one or more processors operatively coupled to the antennas and configured to process the received signals.

10. A method according to claim 2 wherein the entity is selected from the group comprising: a digit of the user and a stylus.

11. A method according to claim 1 wherein the first computer is from the group consisting of: a desktop personal computer, a laptop computer, a tablet computer, a mobile station, an entertainment appliance, a set-top box communicatively coupled to a television, a wireless phone, a smartphone, a netbook, and a game console.

12. A method of receiving, from a first computer, information at a second computer, the second computer comprising a display, a gesture module, a device-detection module, and a receiving module, the display being a touch-sensitive display, the method comprising:
identifying, by the device-detection module, a direction in which the first computer is located relative to the second computer; and
displaying, by the display, to a user of the second computer, an indication that information is to be received by the second computer, a position of the indication on the display being dependent upon the direction in which the first computer is located relative to the second computer; and
in response to receiving an input, by the gesture module, from the display, receiving, by the receiving module, from the first computer, the information;
wherein the input specifies a direction relative to the second computer, the direction specified by the input being substantially the same direction as the direction in which the first computer is located relative to the second computer, the input being generated by the user of the second computer performing a gesture, the gesture comprising the user contacting, with an entity, the display.

13. A method according to claim 12 wherein the gesture that generates the input comprises sliding, by the user, the entity across at least a portion of the display.

14. A method according to claim 13 wherein the direction that is specified by the input is the direction in which the entity is slid, by the user, across at least a portion of the display.

15. A method according to claim 12:
wherein the second computer further comprises a bezel;
wherein the bezel is a touch-sensitive bezel;
wherein the input is received by the gesture module from the display and from the bezel; and
wherein the gesture comprises the user contacting, with an entity, the display and the bezel.

16. A method according to claim 15 wherein the gesture that generates the input comprises:
contacting, by the user, a point on the bezel with the entity; and
sliding, by the user, the entity from the bezel, onto the display, and across at least a portion of the display.

17. A method according to claim 16 wherein sliding of the entity, by the user, across at least a portion of the display specifies the direction for the input, the specified direction being the direction in which the entity is slid by the user.

18. A method according to claim 11 wherein the device-detection module comprises a system selected from the group consisting of: a radiated communication system, a global positioning system, a system configured to determine an orientation of the first computer, and a plurality of antennas located at different positions and configured to receive a signal from the first computer and one or more processors operatively coupled to the antennas and configured to process the received signals.

19. A computer comprising:
a gesture module;
a device-detection module; and
a transmission module;
wherein the gesture module is configured to receive an input, the input specifying or identifying information that is to be sent from the computer to a further computer, the input specifying a direction relative to the computer, the input being generated by a user of the computer performing a gesture;
wherein the device-detection module is operatively connected to the gesture module and is configured to identify, using the direction specified by the input, the further computer, the further computer being located relative to the first computer substantially in the direction specified by the input; and
wherein the transmission module is operatively connected to the gesture module and to the device-detection module and is configured to send, to the further computer, the information specified or identified by the input.

20. A computer comprising:
a touch-sensitive display;
a gesture module;
a device-detection module; and
a receiving module;
wherein the device-detection module is configured to identify a direction in which a further computer is located relative to the computer, the further computer being a computer from which information is to be received by the computer;
wherein the display is operatively coupled to the device-detection module and is configured to display an indication that information is to be received by the computer, a position of the indication on the display being dependent upon the direction in which the further computer is located relative to the computer;
wherein the gesture module is operatively coupled to the display and is configured to receive an input from the display;
wherein the receiving module is operatively coupled to the gesture module and is configured to, in response to the gesture module receiving the input, receive, from the further computer, the information; and
wherein the input specifies a direction relative to the computer, the direction specified by the input being substantially the same direction as the direction in which the further computer is located relative to the computer, the input being generated by a user of the computer performing a gesture, the gesture comprising the user contacting, with an entity, the display.
